(19) United States
(12) Patent Application Publication
(10) Pub. No.: US 2003/0066913 A1
(43) Pub. Date: Apr. 10, 2003

(54) Interchangeable wheel drive assembly for sprinkler irrigation system

(76) Inventors: Richard F. Reinke, Deshler, NE (US); Robert Nolan Reinke, Deshler, NE (US)

Correspondence Address: THOMPSON & THOMPSON, P.A., 310 4th Street, P.O. Box 66, Scandia, KS, 66966, US

(21) Appl. No.: 09/971,967

(22) Filed: Oct. 4, 2001

(51) Int. Cl. B05B 3/00

(52) U.S. Cl. 239/735; 239/743; 239/744; 239/723

(57) ABSTRACT

A wheel drive assembly for sprinkler irrigation systems includes an input shaft having a first bevel gear, a wheel gear, and a reduction gear assembly interconnecting the first bevel gear and the wheel gear. The reduction gear assembly has a first spur gear and a second bevel gear mounted on a common shaft. First and second input openings are disposed on respective sides of a housing of the wheel drive assembly. An input shaft extends through one of the input openings, and the other input opening is covered by a cover member. The housing has threaded bolt holes for attaching the housing to a support tower in selected positions. The wheel drive assembly is convertible between left-hand and right-hand operation by reversing the mounting position of the second bevel gear on the common shaft, interchanging the input shaft and cover member, and rotating the housing to a different mounting position.

### BACKGROUND OF THE INVENTION

1. Field of the Invention

The present invention relates generally to sprinkler irrigation systems that employ a plurality of wheeled support towers secured to and spaced along the length of a water distribution pipe. In particular, the present invention relates to an improved gear drive assembly for driving the wheels of the support towers of a sprinkler irrigation system.

2. Description of the Related Art

Sprinkler irrigation systems are widely used throughout the world to provide water for agricultural purposes in arid regions. Typically, such systems include a series of spaced support towers connected by truss sections that support an elevated water distribution pipe between the towers. In center pivot systems, the water distribution pipe extends radially from a central pivot communicating with a pressurized water supply. In linear move irrigation systems, the water distribution pipe extends laterally from a canal feed or hose drag system that provides a pressurized water supply.

Water passing through the distribution pipe is forced out through a number of sprinkler heads, spray guns, drop nozzles, and the like, spaced along the length of the pipe. Each tower in the system is supported on wheels that are driven at slow speeds to move the tower in a circular path about the central pivot, or a linear path in the case of linear move systems, to thereby irrigate a large tract of land.

A number of drive assemblies have been developed for driving the support wheels of sprinkler irrigation systems. The most widely used drive assembly in the industry today is a worm gear drive developed by the present Applicant, which is described in the applicant's prior U.S. Pat. No. 3,623,662. The conventional worm gear drive includes an electric motor connected to a center gear drive assembly, a first wheel gear assembly coupled to the center gear drive assembly by a first drive shaft, and a second wheel gear assembly coupled to an opposite side of the center gear drive assembly by a second drive shaft. Worm pinions are provided at the ends of the first and second drive shafts within the first and second wheel gear assemblies. A worm wheel is carried by the hub of each support wheel and is placed in meshing engagement with a respective worm pinion mounted on the output shafts. The worm wheel is thus driven by the worm pinion upon rotation of the output shaft, thereby causing the support wheel to rotate and move the respective tower of the irrigation system. The conventional worm gear drive provides a 50:1 gear reduction ratio between the output shaft of the drive motor and the hub of the support wheel.

The conventional worm gear drive assembly disclosed in the applicant's U.S. Pat. No. 3,623,662, provided a simple, dependable, and relatively inexpensive construction. Moreover, the conventional worm gear drive assembly provided a significant advantage over earlier drive arrangements in that the meshing of the worm pinion with the worm wheel prevented the driven support wheels from rolling freely forward or backward as the irrigation system traverses uneven terrain. These advantages were quickly recognized throughout the industry and have made the conventional worm gear drive disclosed in the applicant's U.S. Pat. No. 3,623,662 the standard and preferred drive assembly for center pivot irrigation systems for many years.

However, the conventional worm gear drive assembly is quite inefficient in transferring power from the drive motor to the driven wheels. For example, the conventional worm gear arrangement operating at slow speeds has an approximate overall efficiency of only 40% due to the friction loss between the worm gear and the worm pinion. The efficiency of the worm gear drive assembly is particularly low in irrigation systems that require intermittent operation of the drive wheels due to the higher static coefficient of friction between the worm gear and the worm pinion. This inefficiency in the drive assembly has resulted in an increased horsepower and energy consumption required to obtain the desired torque and speed for moving the support towers of the irrigation system.

A variety of other gear drive arrangements have been developed for center pivot irrigation systems. For example, a gear drive arrangement with an additional reduction gear assembly to improve efficiency is disclosed in applicant's prior U.S. Pat. No. 5,862,997. However, these conventional worm gear drive assemblies still suffer from a lack of efficiency due to the use of a worm gear. Thus, there is a need in the industry for further improvements in wheel gear drive assemblies for sprinklers.

### SUMMARY OF THE INVENTION

It is an object of the present invention to provide a sprinkler irrigation system having an improved gear drive assembly that solves the problems associated with the conventional gear drive assemblies described above.

More specifically, it is an object of the present invention to provide a gear drive assembly for a sprinkler irrigation system which offers improved drive efficiencies and which can be interchanged between right and left-hand operation for use at either end of a support tower of the irrigation system.

It is a further object of the present invention to provide a sprinkler irrigation system having an improved gear drive assembly as described herein.

It is a still further object of the present invention to provide an improved gear drive assembly that is economical to manufacture, efficient in use, capable of a long operating life, and particularly well suited for driving the wheels in sprinkler irrigation systems.

The present invention provides an improved wheel drive assembly for sprinkler irrigation systems that accomplishes these objectives. The wheel drive assembly includes an input shaft having a first bevel gear mounted for rotation with the input shaft, a wheel gear connected to one of the drive wheels of the sprinkler system, and a reduction gear assembly interconnecting the first bevel gear and the wheel gear. The reduction gear assembly has a first spur gear and a second bevel gear mounted on a common shaft. The second bevel gear meshes with the first bevel gear, and the first spur gear meshes with the wheel gear. The orientation of the second bevel gear on the shaft of the reduction gear assembly is reversible to provide either left-hand or right-hand operation.

First and second input openings are disposed 90 degrees apart from each other on respective sides of the housing of the wheel drive assembly. An input shaft extends through one of the input openings and has the first bevel gear mounted on an end thereof. The other input opening is covered by a cover member. The input shaft and cover member are interchangeable between the input openings to allow the input shaft to be properly positioned in a desired one of the input openings when the wheel drive assembly is mounted for either left-hand or right-hand operation.

The housing has threaded bolt holes for attaching the wheel drive assembly in either of two possible positions on the right and left sides of the support tower of the sprinkler system. The threaded bolt holes are placed in a pattern that allows the housing to be attached to the existing bolt holes on the support tower in a selected position for left-hand or right-hand operation. The wheel drive assembly is convertible between left-hand and right-hand operation by reversing the mounting position of the second bevel gear on the common shaft, interchanging the input shaft and cover member, and rotating the housing 90 degrees to a different mounting position.

Numerous other objects and advantages of the present invention will be apparent to those skilled in this art from the following description wherein there is shown and described a preferred embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a perspective view of one of the support tower assemblies for supporting an irrigation pipe of a sprinkler irrigation system according to the present invention.

FIG. 2 is a detailed sectional view, on an enlarged scale, as viewed in the direction of the section line 2-2 of FIG. 1, illustrating the structure of the improved gear drive assembly of the present invention.

FIG. 3 is a cutaway perspective view of the improved gear drive assembly according to the present invention.

FIG. 4 is a front view, in partial section, of the gear drive assembly according to the present invention, as viewed in the direction of the section line 4-4 of FIG. 1.

FIGS. 5(a) and 5(b) are front views of a right-hand position and a left-hand position, respectively, of the gear drive assembly according to the present invention.

FIG. 6 is a sectional front view of the gear drive assembly of the present invention as viewed in the same direction as the front view of FIG. 4.

FIGS. 7(a) and 7(b) are sectional side views of the left hand and right-hand positions, respectively, of the gear drive assembly of the present invention, as viewed in the direction of section lines 7(a)-7(a) and 7(b)-7(b), respectively, in FIG. 1.

### DETAILED DESCRIPTION OF THE PREFERRED EMBODIMENT

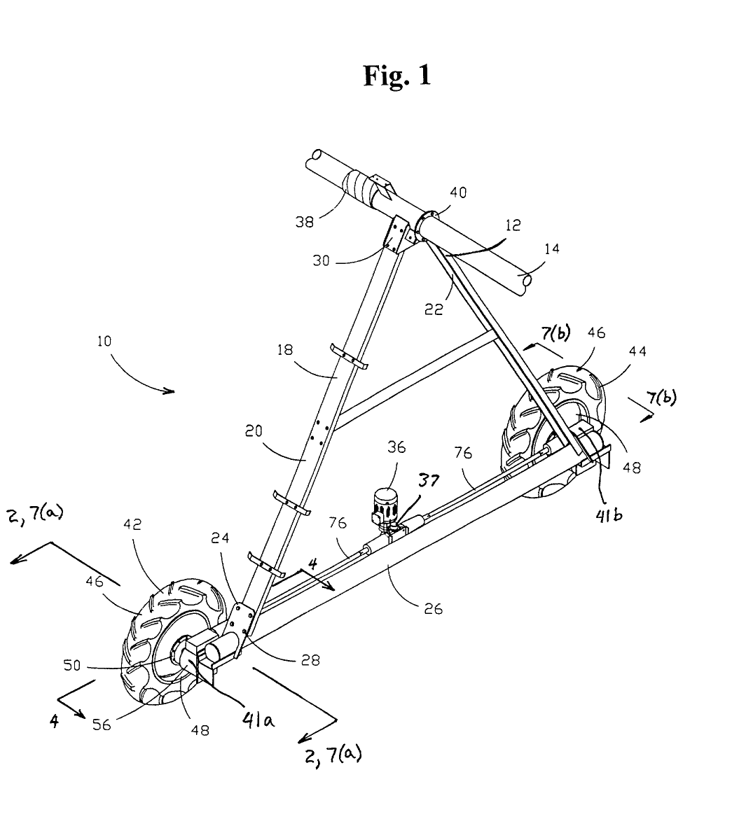

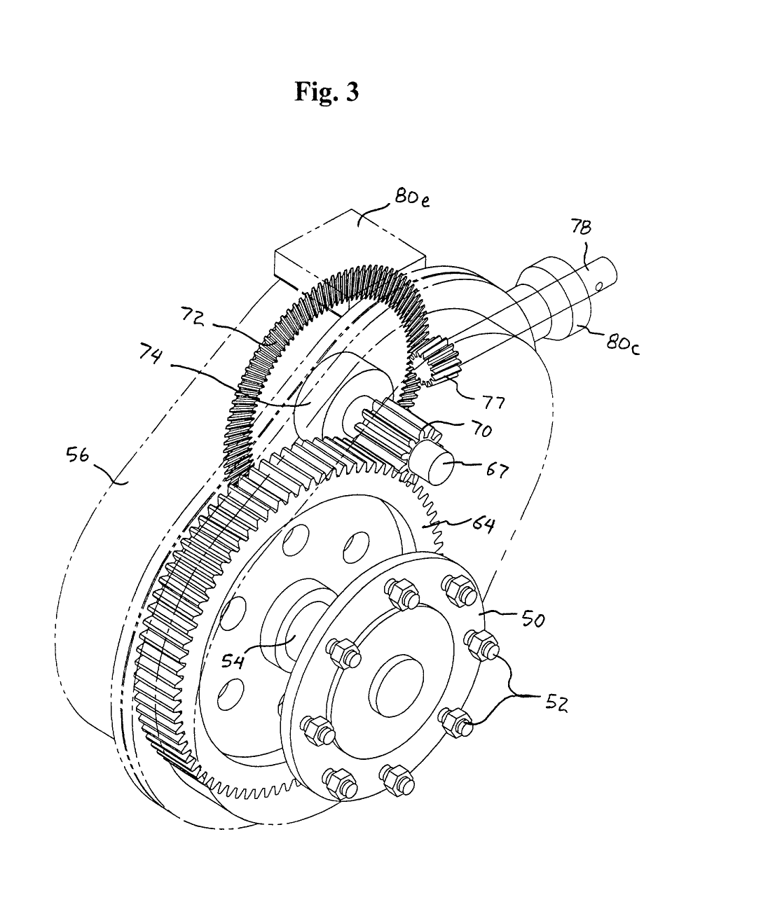

A sprinkler irrigation system 10 having an improved gear drive assembly according to the present invention will now be described with reference to FIGS. 1 to 7(b) of the accompanying drawings.

The sprinkler irrigation system 10 has a plurality of support tower assemblies 12 that support an irrigation pipe or boom 14 above a field to be irrigated. The irrigation boom or pipe 14 is in the form of an elongated tubular pipe having a plurality of discharge openings spaced along a length thereof. The support tower assemblies 12 have generally A-shaped constructions formed by a pair of downwardly diverging frame members 20 and 22, which extend both forwardly and rearwardly from the pipe 14, as shown in FIG. 1. The lower ends of the members 20 and 22 are each connected to a horizontally disposed tubular frame member 26, as by welding or the like. The upper ends of the members 20 and 22 are secured to the pipe 14 by suitable bracket structures generally designated by the numeral 30. Each of the support tower assemblies 12 has a control system (not shown) having a power cable (not shown) extending therefrom for operating an electric drive motor 36. The drive motor 36 has a gearbox 37 associated therewith for providing a suitable gear reduction and for outputting rotational energy to front and rear drive shafts 76.

A flexible coupling 38 is provided in the pipe 14 adjacent to each support tower assembly 12 to permit the pipe 14 to flex as the irrigation system traverses uneven terrain. The flexible coupling 38 also functions to reduce stress in the pipe 14 in the event that one or more of the support tower assemblies 12 become misaligned with the other support assemblies along the length of the irrigation system. A flanged coupling 40 is provided adjacent to each support tower assembly 12 to facilitate assembly and disassembly of the irrigation system. The flanged coupling 40 is provided with an O-ring seal that fits in a groove on both flanges of the flanged coupling 40. The control system (not shown) controls the operation of the electric motor 36 in response to deflection of adjacent pipe sections 14 about an axis defined by a specific construction of the flexible coupling 38.

Left and right support wheel assemblies 42, 44 are located at opposite ends of the support frame member 26. Each wheel assembly 42, 44 includes a pneumatically inflated tire 46 supported on a conventional wheel rim 48 secured in place on a hub 50 by lug bolts 52 to enable conventional vehicular wheels to be employed.

The improvement provided by the present invention is directed toward the wheel gear drive assemblies 41a, 41b associated with each of the support wheel assemblies 42, 44. The wheel gear drive assemblies 41a, 41b each include a shaft 54 extending from the hub 50 which is supported within an annular housing 56 by first and second bearing assemblies 58. The housing 56 includes a removable side plate 59 secured in place by suitable fastening bolts 57. A seal 60 is provided between the shaft 54 and the housing 56 to keep lubricating fluid within the housing 56 and to prevent dust and debris from entering the housing 56. The shaft 54 is retained in position by the bearing assemblies 58, which are assembled within the housing 56 when the side plate 59 is attached. The housing 56 is secured to the frame member 26 of the support tower assembly 12 by suitable fastening bolts 61 or the like to enable torque to be transmitted through the housing 56 to the wheel assemblies 42, 44.

A wheel gear 64 is secured to the shaft 54 between the first and second bearing assemblies 58. The wheel gear 64 is preferably a spur gear which is keyed to the shaft 54 for rotation with the wheels 42, 44.

A reduction gear assembly 66 is mounted for rotation within the housing 56 adjacent to the wheel gear 64. The reduction gear assembly 66 has a shaft 67 supported at its ends by suitable bearings 68. The reduction gear assembly 66 has a first gear 70 with a relatively small diameter secured to the shaft 67 for rotation therewith. The first gear 70 is preferably a spur gear with teeth which are intermeshed with the gear teeth on the wheel gear 64. Thus, the wheel gear 64 along with the shaft 54 and wheels 42, 44 are rotated upon rotation of the first gear 70. The first gear 70 has a smaller diameter than the wheel gear 64.

The reduction gear assembly 66 has a second gear 72, which is preferably a bevel gear and which is larger in diameter than the first gear 70. The second gear 72 is secured to or formed integral with a spacer hub 74. The spacer hub 74 has a bore through its center which is sized to fit over the shaft 67. A conventional clamping or locking structure, such as a keyway with a key and one or more set screws, is provided to removably secure the spacer hub 74 to the shaft 67. A back side of the spacer hub 74 and the second gear 72 are provided with a recessed portion 75 for accommodating a protruding portion of the housing 56 in which one of the bearings 68 is located for supporting the shaft 67.

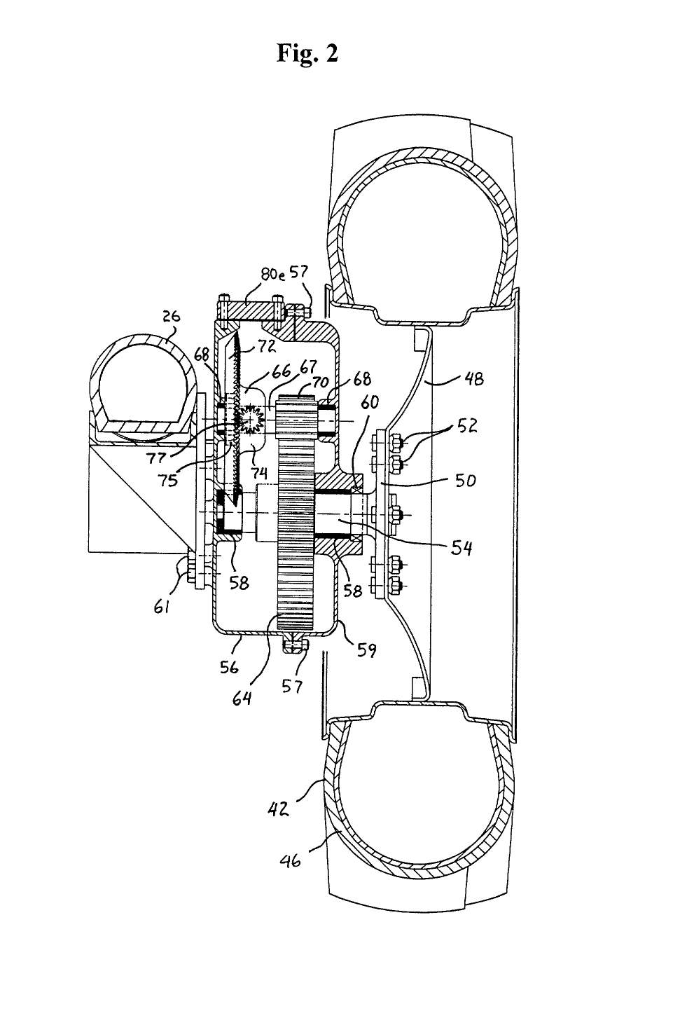

An input bevel gear 77 is secured to a shaft 78 within the housing 56. The input bevel gear 77 is intermeshed with the gear teeth on the second bevel gear 72 of the reduction gear assembly 66 to cause the second bevel gear 72 to rotate upon rotation of the input bevel gear 77. The input bevel gear 77 has a smaller diameter than the second bevel gear 72. The shaft 78 on which the input bevel gear 77 is mounted is coupled to an end of a drive shaft 76 extending from the gearbox 37 associated with the electric drive motor 36. The input bevel gear 77 and the second bevel gear 72 are rotatable about respective axes that intersect each other, as shown in FIGS. 2, 4 and 6.

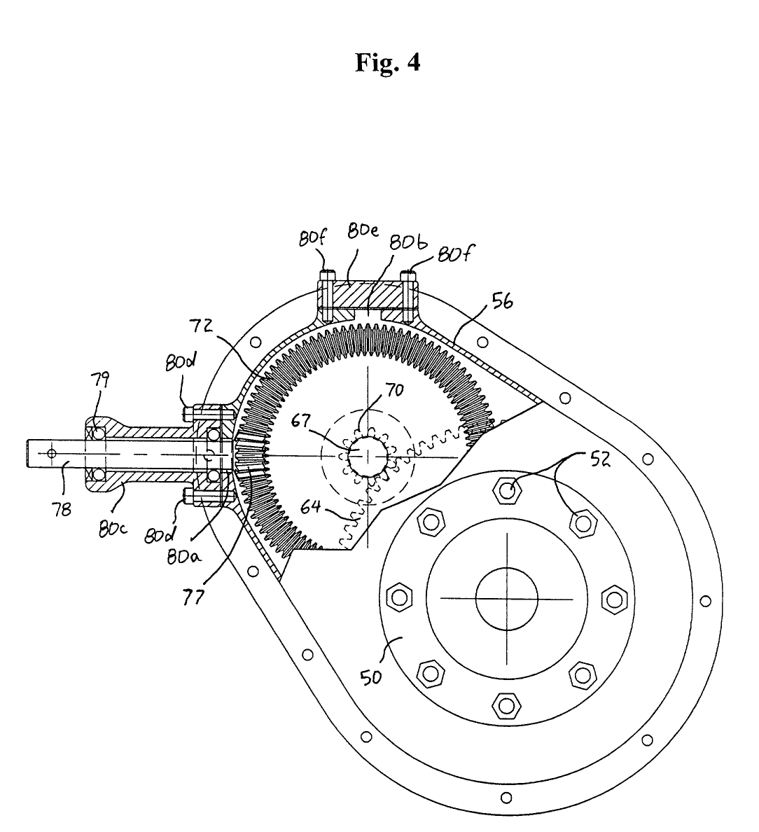

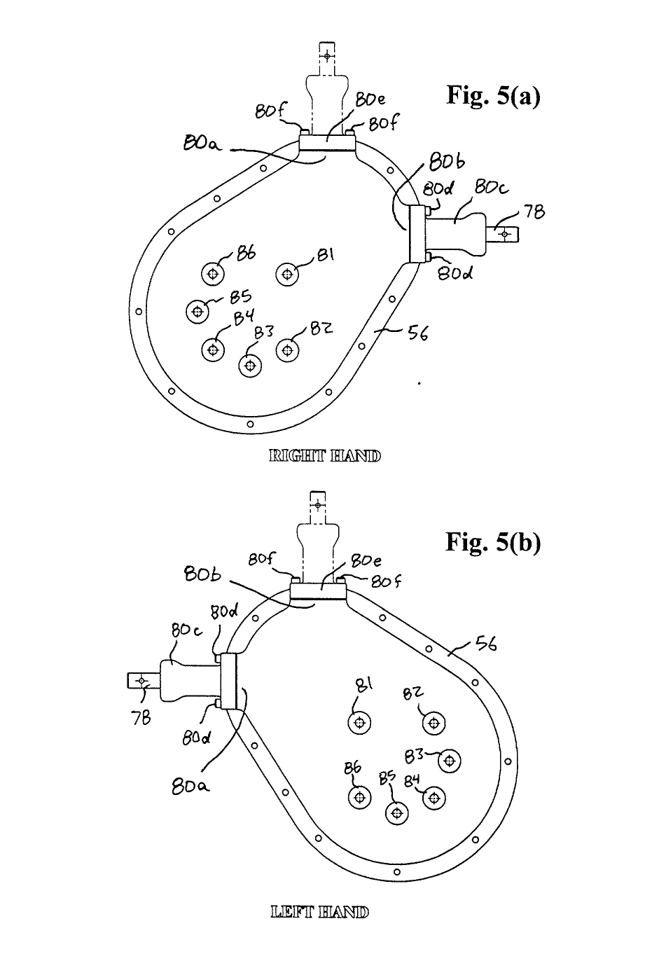

The shaft 78 extends through a selected first input opening 80a or a second input opening 80b of the housing 56 depending on whether the gear drive assembly is to be placed in service in its left-hand position or its right-hand position, respectively. In the left-hand position shown in FIGS. 4, 5(b) and 6, the shaft 78 extends through the first input opening 80a. In the right-hand position shown in FIG. 5(a), the shaft 78 extends through the second input opening 80b. The shaft 78 is supported by a removable sleeve member 80c attached to the housing 56 by threaded fasteners 80d. The sleeve member 80c includes a pair of suitable bearing assemblies 79 to facilitate smooth rotation of the shaft 78 within the sleeve member 80c.

A cover member 80e is attached by threaded fasteners 80f to the housing 56 over the second input opening 80b in the left-hand position shown in FIGS. 4, 5(b) and 6, or over the first input opening 80a in the right-hand position shown in FIG. 5(a). The first and second input openings 80a and 80b have substantially the same construction. Therefore, the sleeve member 80c and cover member 80e can be interchanged between the first and second input openings 80a, 80b when the gear drive assembly is changed from its left-hand position to its right-hand position.

As mentioned above, the gear drive assembly of the present invention is interchangeable between a left-hand position and a right-hand position to be used on either end of the support tower. To accomplish this changeover, the second gear 72 and its spacer hub 74 are reversible on the shaft 67, as shown in FIGS. 7(a) and 7(b). In the left-hand position shown in FIG. 7(a), the second bevel gear 72 is positioned with its teeth facing toward the first spur gear 70 with the teeth of the first and second bevel gears 70, 77 intermeshing on the left side of the axis of rotation of the first bevel gear 72. In the right-hand position shown in FIG. 7(b), the second bevel gear 72 is positioned with its teeth facing away from the first spur gear 70 with the teeth of the first and second bevel gears 70, 77 intermeshing on the right side of the axis of rotation of the first bevel gear 72.

The second gear 72 can be changed between its left-hand and right-hand positions by partially disassembling the wheel gear drive assembly 41a, 41b to remove the reduction gear assembly 66 from within the housing 56. The second gear 72 and spacer hub 74 are then removed from the shaft 67, turned over 180 degrees, and replaced on the shaft 67 in the desired opposite orientation. By changing the second gear 72 from its left-hand position to its right-hand position, the direction of rotation of the reduction gear assembly 66 is reversed. As a result, the direction of rotation of the wheel hub 50 can be reversed while maintaining the same direction of rotation of the input bevel gear 77 and shaft 78.

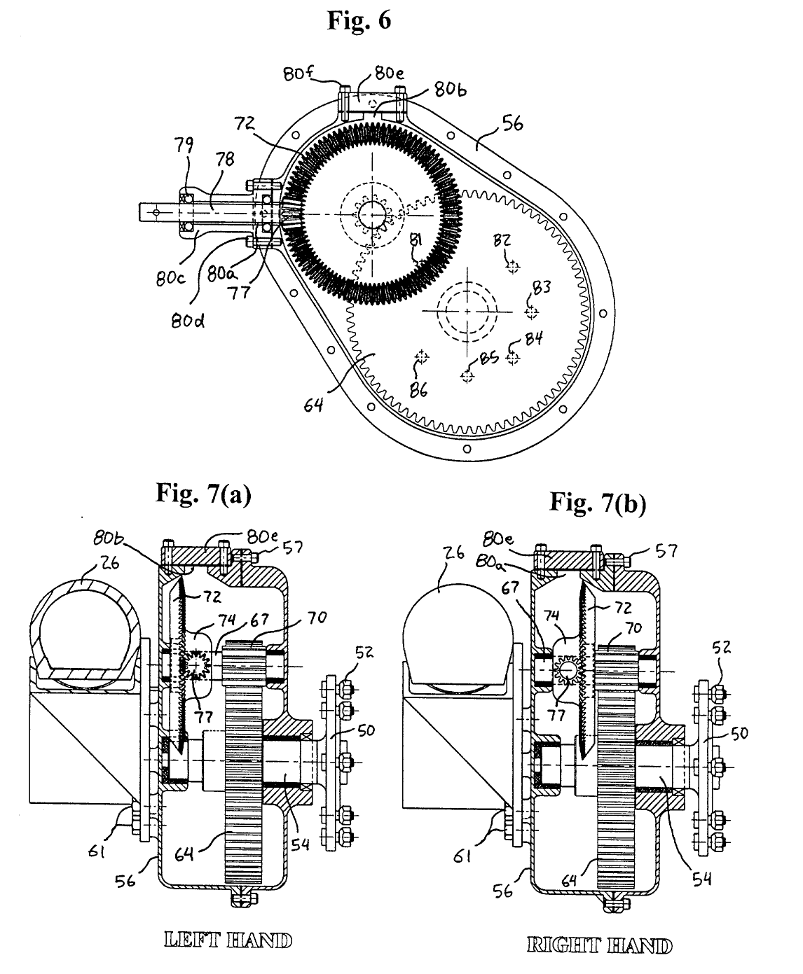

The housing 56 of the wheel gear drive assemblies 41a, 41b can be secured to the frame member 26 at either end of the frame member 26 of the support tower assembly 12 as follows. The housing 56 includes a pattern of six threaded openings 81-86 spaced asymmetrically about an axis of rotation of the wheel gear 64, as shown in FIGS. 5(a), 5(b), and 6. The threaded openings 81-86 are used to receive a total of five fastening bolts 61 for securing the housing 56 to the frame member 26. The five fastening bolts 61 are inserted through the five existing holes (not shown) in the frame member 26. In the right-hand position shown in FIG. 5(a), the five fastening bolts 61 are received in the threaded openings 81, 82, 83, 84 and 86, but not in the opening 85. In the left-hand position shown in FIG. 5(b), the five fastening bolts 61 are received in the threaded openings 81, 82, 84, 85 and 86, but not in the opening 83. With this arrangement of threaded openings 81-86, the housing 56 can be mounted to the frame member 26 in two different positions angularly spaced 90 degrees from each other using the existing five holes in the frame member 26, the same five fastening bolts 61, and only one additional threaded opening in the housing 56.

As explained above, the wheel gear drive assembly 41a, 41b of the present invention can be placed in service at either end of the support tower assemblies 12 of existing sprinkler irrigation systems. The gear drive assembly 41a, 41b is changeable between right-hand and left-hand operating positions by interchanging the input openings 80a, 80b used by the sleeve member 80c and the cover member 80e, by reversing the second gear 72 on the shaft 67 of the reduction gear assembly 66, and by rotating the entire assembly 90 degrees and using a different combination of mounting openings 81-86 to secure the housing 56 to the frame member 26.

The present invention provides a wheel gear drive assembly 41a, 41b that relies upon bevel gears 72, 77 and spur gears 64, 70 to accomplish a necessary gear reduction ratio and direction change between the output shaft 76 of the center gearbox 37 and the wheel hub 50. As a result, an efficiency of the wheel gear drive assembly 41a, 41b is improved over conventional worm gear drive assemblies. Moreover, the wheel gear drive assembly 41a, 41b of the present invention can be assembled and installed for either right-hand operation or left-hand operation using the same gear housing 56 and other components, thereby minimizing manufacturing and inventory costs.

The gear reduction ratio between the input bevel gear 77 and the second gear 72 is preferably within a range of about 4:1 to 9:1, and most preferably about 6.25:1. The gear reduction ratio between the first gear 70 and the wheel gear 64 is preferably within a range of about 6:1 to about 10:1, and most preferably about 8:1. In a preferred embodiment, an overall gear reduction ratio of approximately 50:1 is achieved by the wheel gear drive assembly 41a, 41b between the input shaft 78 and the wheels 42, 44. This gear reduction ratio of 50:1 is consistent with the gear ratios of most existing worm gear drives used in the industry and will allow the improved gear assembly of the present invention to be used on existing sprinkler towers without further modification.

The bearing assemblies 58, 68 and 79 used in the wheel gear drive assemblies 41a, 41b can be tapered roller bearings, bronze bearings, and other conventional bearing structures.

It will be appreciated that the present invention is not limited to the exact constructions that have been described above and illustrated in the accompanying drawings, and that various modifications and changes can be made without departing from the scope and spirit of the invention. The scope of the appended claims should be construed as broadly as the prior art will permit.

What is claimed is:

1. A sprinkler irrigation system having an improved wheel drive assembly, comprising:
an elongated pipe having one end connected to a source of water and having a plurality of outlets for discharging water; and
at least one support assembly for supporting the elongated pipe over an area to be irrigated, each support assembly including at least one drive wheel for propelling the support assembly and a final gear drive assembly associated with said drive wheel;
said final gear drive assembly comprising an input shaft having a first bevel gear mounted for rotation with said input shaft, a wheel gear connected to said drive wheel for rotation therewith, and a reduction gear assembly having first and second gears interconnecting said wheel gear and said first bevel gear for providing a gear reduction between said first bevel gear and said wheel gear.

2. The irrigation system according to claim 1, wherein said first and second gears of said reduction gear assembly are a first spur gear and a second bevel gear, respectively, said first bevel gear being intermeshed with said second bevel gear, and said first spur gear being intermeshed with said wheel gear, whereby rotation of said first bevel gear causes rotation of said wheel via said reduction gear assembly and said wheel gear.

3. The irrigation system according to claim 2, wherein said second bevel gear of the reduction gear assembly is larger in diameter than said first spur gear of the reduction gear assembly.

4. The irrigation system according to claim 2, wherein said wheel gear is a spur gear which intermeshes with said first spur gear of the reduction gear assembly, said wheel gear having a larger diameter than said first spur gear.

5. The irrigation system according to claim 2, wherein said first and second bevel gears provide a gear reduction ratio within a range of approximately 4:1 to 9:1.

6. The irrigation system according to claim 2, wherein said first spur gear of the reduction gear assembly and said wheel gear provide a gear reduction ratio within a range of approximately 6:1 to 10:1.

7. The irrigation system according to claim 2, wherein said first and second bevel gears provide a gear reduction ratio of approximately 6.25:1, and said first spur gear of the reduction gear assembly and said wheel gear provide a gear reduction ratio of approximately 8:1, whereby a combined gear reduction ratio of said final gear drive assembly is approximately 50:1.

8. The irrigation system according to claim 2, wherein said first bevel gear and said second bevel gear are rotatable about respective axes which intersect each other.

9. The irrigation system according to claim 1, wherein said first bevel gear, said reduction gear assembly, and said wheel gear are all mounted for rotation within a housing adjacent to said at least one drive wheel.

10. The irrigation system according to claim 1, wherein said at least one drive wheel comprises left and right drive wheel assemblies, said final gear drive assembly comprises first and second final gear drive assemblies associated with said left and right drive wheel assemblies, respectively, and further comprising a drive motor positioned between said left and right drive wheels, and a pair of drive shafts extending between respective sides of a gearbox connected to said drive motor and said first and second final gear drive assemblies.

11. The irrigation system according to claim 1, wherein said final gear drive assembly comprises a housing in which said wheel gear, said reduction gear assembly, and said first bevel gear are disposed, said housing having a pattern of threaded openings for attaching the housing to the support tower in a first mounting position for left-hand operation and a second mounting position for right-hand operation, said first mounting position being angularly spaced approximately 90 degrees about an axis of said wheel gear from said second mounting position.

12. The irrigation system according to claim 11, wherein said pattern of threaded bolt holes comprises six holes spaced asymmetrically about an axis of rotation of said wheel gear, and said housing is attached to the support tower in either of said first and second mounting positions using five threaded bolts inserted into a selected five of said six holes.

13. The irrigation system according to claim 11, wherein said housing includes first and second input openings disposed on respective sides of said housing spaced approximately 90 degrees apart from each other, said first input opening having an input shaft extending therethrough with said first bevel gear attached on an end of the input shaft within said housing.

14. The irrigation system according to claim 13, wherein said second input opening has substantially the same construction as said first input opening and is covered by a cover member, said input shaft and said cover member being interchangeable between said first and second input openings to change said gear drive assembly between left-hand operation and right-hand operation.

15. The irrigation system according to claim 1, wherein said reduction gear assembly includes a shaft on which said first spur gear and said second bevel gear are mounted, said second bevel gear is reversible on the shaft between a first mounting position in which teeth of the first and second bevel gears intermesh on one side of an axis of rotation of the first bevel gear, and a second mounting position in which the teeth of the first and second bevel gears intermesh on another side of the axis of rotation of the first bevel gear, said final gear drive assembly being convertible between left-hand operation and right-hand operation by reversing the mounting position of said second bevel gear.

16. A sprinkler irrigation system having an improved wheel drive assembly, comprising:
an elongated pipe having one end connected to a source of water and having a plurality of outlets for discharging water; and
at least one support assembly for supporting the elongated pipe over an area to be irrigated, each support assembly including at least one drive wheel for propelling the support assembly and a final gear drive assembly associated with said drive wheel;
said final gear drive assembly comprising a housing in which a wheel gear and a reduction gear assembly are disposed, said housing having a pattern of threaded openings for attaching the housing to the support assembly in a first mounting position for left-hand operation and a second mounting position for right-hand operation, said first mounting position being angularly spaced approximately 90 degrees about an axis of said wheel gear from said second mounting position.

17. The irrigation system according to claim 16, wherein said pattern of threaded bolt holes comprises six holes spaced asymmetrically about an axis of rotation of said wheel gear, and said housing is attached to the support tower in either of said first and second mounting positions using five threaded bolts inserted into a selected group of said six threaded bolt holes.

18. The irrigation system according to claim 16, wherein said housing includes first and second input openings disposed on respective sides of said housing spaced approximately 90 degrees apart from each other, said first input opening having an input shaft extending therethrough with a first bevel gear attached on an end of the input shaft within said housing.

19. The irrigation system according to claim 18, wherein said second input opening has substantially the same construction as said first input opening and is covered by a cover member, said input shaft and said cover member being interchangeable between said first and second input openings to change said gear drive assembly between left-hand operation and right-hand operation.

20. A sprinkler irrigation system having an improved wheel drive assembly, comprising:
an elongated pipe having one end connected to a source of water and having a plurality of outlets for discharging water; and
at least one support assembly for supporting the elongated pipe over an area to be irrigated, each support assembly including at least one drive wheel for propelling the support assembly and a final gear drive assembly associated with said drive wheel;
said final gear drive assembly comprising an input shaft having a first bevel gear mounted for rotation with said input shaft about an input axis of rotation, a wheel gear connected to said drive wheel for rotation therewith, and a reduction gear assembly interconnecting said wheel gear and said first bevel gear for providing a gear reduction between said first bevel gear and said wheel gear, said reduction gear assembly comprising a first spur gear and a second bevel gear mounted on a common shaft, said second bevel gear being reversible on said common shaft between a first mounting position in which teeth of the first and second bevel gears intermesh on one side of said input axis, and a second mounting position in which the teeth of the first and second bevel gears intermesh on another side of said input axis, said final gear drive assembly being convertible between left-hand operation and right-hand operation by reversing the mounting position of said second bevel gear.
